(19) United States
(12) Patent Application Publication
(10) Pub. No.: US 2015/0343347 A1
(43) Pub. Date: Dec. 3, 2015

(54) CONNECTOR FOR A FILTER PLATE

(71) Applicant: OUTOTEC (FINLAND) OY, Espoo (FI)

(72) Inventor: Rolf HINDSTRÖM, Turku (FI)

(73) Assignee: Outotec (Finland) Oy, Espoo (FI)

(21) Appl. No.: 14/759,540

(22) PCT Filed: Jan. 9, 2014
(86) PCT No.: PCT/FI2014/050015

§ 371 Date: Jul. 7, 2015

(30) Foreign Application Priority Data
Jan. 10, 2013 (FI) 20135030

(51) Int. Cl. B01D 35/02; B01D 35/30; B01D 29/41

(52) U.S. Cl. CPC B01D 35/02; B01D 29/413; B01D 35/306

(57) ABSTRACT

A connector (19) for a filter plate comprises an elbow fitting (20) connectable onto a first plane surface of a filter plate, a counterpart connectable onto a second plane surface of the filter plate, and a bolt (22) for fastening the elbow fitting (20) to the counterpart (21). The elbow fitting (20) comprises an inlet (24) connectable to an internal cavity of the filter plate and an outlet (25) connectable to a drainage line of a disc filter so that the elbow fitting (20) is able to act as a fluid communication channel between the internal cavity and the drainage line.

### FIELD OF THE INVENTION

The invention relates to a connector for placing an internal cavity of a filter plate in fluid communication with a drainage line of a disc filter.

### BACKGROUND OF THE INVENTION

Ceramic filter plates that can be used in disc filters comprise a porous substrate covered by a membrane and an internal cavity for receiving filtrate that has penetrated through the membrane and the substrate. The cavity is provided with an outlet for discharge of the filtrate, and the outlet is provided with a connector for connecting the outlet to a drainage line of the disc filter. The filter plate also comprises means for mounting the filter plate to the central body of the disc filter. The mounting means are contained in the base of the plate. The discs are rotated in a basin containing slurry so that the lower discs proceed in the slurry. Due to suction transmitted via the drainage outlet, a cake is formed on the plane surfaces of the sector-shaped filter plates. After being rotated above the slurry surface the cake is removed. Each disc consists of a plurality of sector shaped ceramic filter plates.

The outlet and connector are usually located in connection with the axial wall of the base so that the connector extends radially from the filter plate. The connector is placed in fluid communication with the drainage line of the disc filter by means of a radial suction pipe or hose. In one embodiment of the prior art, the connector is glued and bolted into the axial wall of the base. In another embodiment of the prior art, the connector is drilled in the axial wall of the base.

A connector protruding radially from the base can cause cracking of the filter plate when the plate is being installed into a disc filter. High mechanical forces are directed into the area of the connector. The filter plate is also weakened by a semi-circular cutout, which is necessary to provide access to the internal cavity of the filter plate.

The flow rate of the filtrate is at its highest close to the drainage outlet in the inner end of the sector plate. A significant pressure drop occurs at the point where the filtrate flow transfers from the internal cavity of the filter plate to the connector. The pressure drop also prevents proper proof testing of filter plates during their manufacture. It is impossible to apply sufficiently high pressure to the internal cavity without damaging the area close to the connector.

The inventors have therefore recognized the need for an improved construction for connecting the internal cavity of the filter plate to the drainage line of the disc filter.

### PURPOSE OF THE INVENTION

The purpose of the invention is to eliminate the problems and drawbacks of the prior art and to provide a new solution for placing the interior of a filter plate in fluid communication with the drainage line of the disc filter.

### SUMMARY

The present invention is characterized by what is presented in the attached claims.

The new connector comprises a first element connectable onto a first plane surface of a filter plate, a second element connectable onto a second plane surface of the filter plate, a bolt for fastening the first element to the second element, an inlet connectable to the internal cavity of the filter plate, and an outlet connectable to the drainage line of the disc filter, which first element is an elbow fitting connectable into a first opening in the first plane surface of the filter plate, the second element is a counterpart connectable into a second opening in the second plane surface of the filter plate, the inlet is located at one end of the elbow fitting, the outlet is located at an opposite end of the elbow fitting and the elbow fitting is able to act as a fluid communication channel between the internal cavity of the filter plate and the drainage line of the disc filter.

According to one aspect of the invention, the elbow fitting comprises a first bushing protruding through the center of the inlet and the counterpart comprises a second bushing, which first bushing and second bushing surround the bolt.

According to one aspect of the invention, the bushings are partly overlapping and there is one or more O-ring seals arranged between the overlapping parts of the bushings.

According to one aspect of the invention, the counterpart comprises one or more lugs for locking the counterpart into the second opening.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a partly sectional plane view of a filter plate.

FIG. 2 is a plane view of a filter plate with a connector of prior art.

FIG. 3 is an axonometric view of a connector of prior art.

FIG. 4 is an axonometric view of a connector according to one embodiment of the present invention.

FIG. 5 is an axonometric cross-sectional view of a filter plate with a connector according to one embodiment of the present invention.

FIG. 6 is an axonometric cross-sectional view of the connector of FIG. 5.

FIG. 7 is an axonometric cross-sectional view showing the through hole in the filter plate.

### DETAILED DESCRIPTION OF SELECTED EMBODIMENTS OF THE INVENTION

The new connector can be used, for instance, in connection with a sector-shaped filter plate 1 shown in FIG. 1. The filter plate 1 comprises a porous substrate 2, which may be, for instance, of ceramic material, and an internal cavity 3 which is surrounded by the substrate 2. The internal cavity 3 may also comprise supporting elements 4 within the cavity 3. Only part of the supporting elements 3 is shown in FIG. 1. The filter plate 1 comprises a first plane surface 5 and a second plane surface 6 on the opposite side of the plate. The filter plate 1 also comprises a base 7, which is provided with bores 8 for mounting the filter plate 1 to the body of a disc filter. Furthermore, the new filter plate 1 comprises a through hole 9 arranged close to the base 7. The discharge outlet from the cavity 3 is arranged in connection with the through hole 9, which is placed so that it passes through the first plane surface 5, the cavity 3 and the second plane surface 6. In this way, the edge of the base 7 can be kept intact. FIG. 7 shows the through hole 9 in more detail. On the first plane surface 5 of the filter plate 1 there is a first opening 9A formed by the through hole 9 and on the second plane surface 6 of the filter plate 1 there is a second opening 9B formed by the through hole 9. One of these openings 9A, 9B acts as the outlet from the cavity 3.

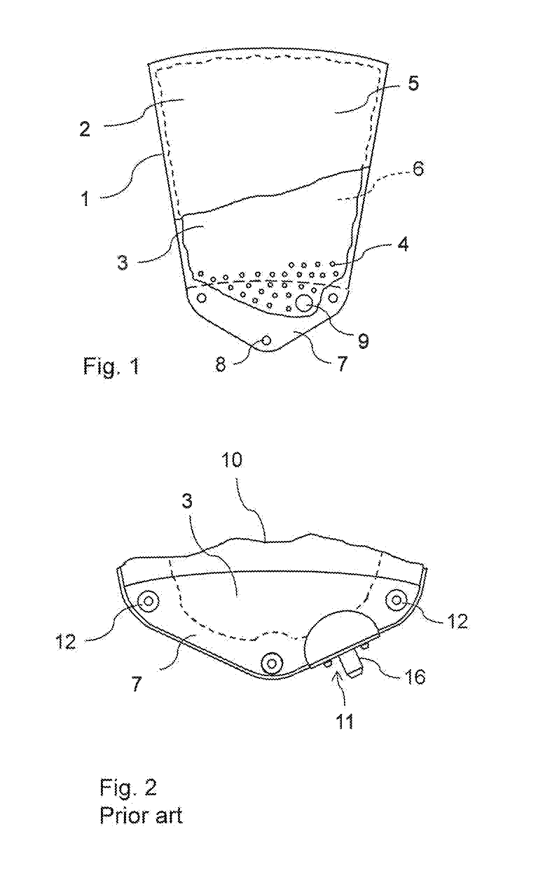

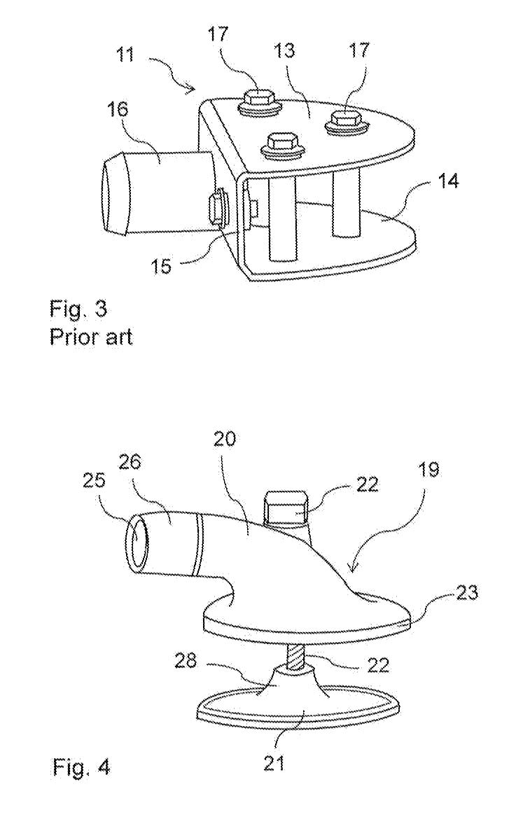

FIG. 3 shows an example of a connector 11 of prior art and FIG. 2 shows the connector 11 fastened to a filter plate 10. FIG. 2 also shows fastening bolts 12 arranged in the base 7 to fasten the filter plate 10 to a disc filter. The connector 11 comprises a first plate 13 and a second plate 14 connected to each other by a side plate 15. The first plate 13 and the second plate 14 are pressed against the plane surfaces of the base 7 of the filter plate 10 and the side plate 15 is pressed against the edge of the base 7. The side plate 15 comprises a socket 16 which is connectable to the drainage line of the disc filter. The connector 11 is fastened to the filter plate 10 by means of glue and a total of five bolts 17. In one embodiment of the known solution, the inner diameter of the outlet is 27 mm and the outer diameter of the same is 31 mm.

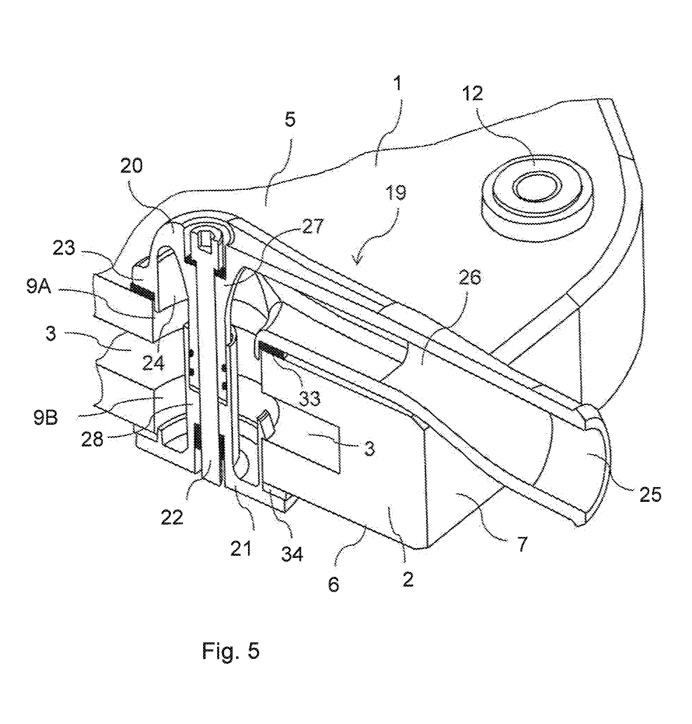

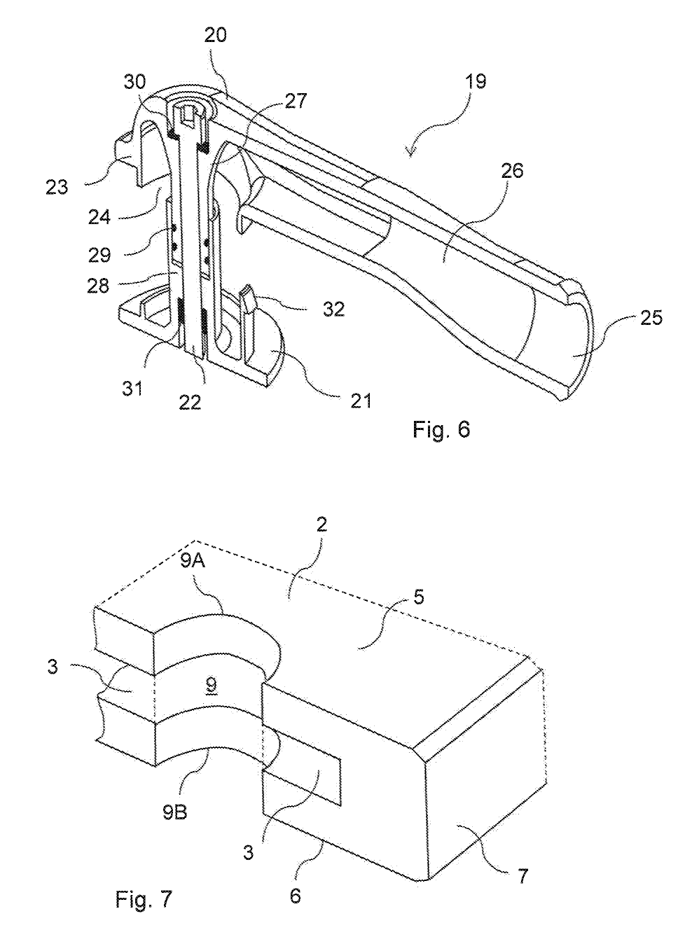

FIG. 4 shows schematically the structure of a connector 19 according to one embodiment of the present invention, FIG. 6 shows the connector 19 in more detail and FIG. 5 shows the connector 19 mounted in a filter plate 1. The new connector 19 comprises an elbow fitting 20, a counterpart 21 and a bolt 22 that clamps the elbow fitting 20 and the counterpart 21 together. The connector 19 is intended to be placed in fluid connection with the through hole 9 provided in the filter plate 1 to enable a fluid communication between the cavity 3 of the filter plate 1 and the drainage line of the disc filter (not shown).

The elbow fitting 20 comprises a circular flange 23 confining an inlet 24 intended to be placed in fluid communication with the opening 9A in the plane first surface 5 of the filter plate 1 and an outlet 25 which is connectable to the drainage line of the disc filter. The inlet 24 and the outlet 25 of the elbow fitting 20 are connected to each other by a tubular section 26. The elbow fitting 20 comprises a first bushing 27 protruding in the middle of the inlet 24, which inlet 24 is essentially perpendicular to the axis of the tubular section 26. The filtrate flowing from the internal cavity 3 to the elbow fitting 20 is made to turn about 90° when arriving to the tubular section 26.

The counterpart 21 is formed as a circular plate that comprises a second bushing 28 protruding from the center of the plate. The elbow fitting 20 and the counterpart 21 are joined together with a bolt 22, which is surrounded the first bushing 27 and the second bushing 28, which are arranged to overlap. O-ring seals 29 are preferably arranged between the bushings 27, 28. Further seals 30, 31 are provided at both ends of the bolt 22 to seal the connection between the bolt 22 and the bushing 27 and 28, respectively. The counterpart 21 comprises at least one lug 32 for locking the counterpart 21 in the position where it closes the second opening 9B in the second plane surface 5 of the filter plate 1.

The through hole 9 is preferably bored at a location close to the edge of the base 7 of the filter plate 1. In this way, the radial edge of the substrate 2 surrounding the cavity 3 is kept intact and the strength of the plate 1 does not decrease because of the outlet 9A and the connector 19 fastened to the outlet 9A.

There is a first gasket 33 arranged between the first plane surface 5 and the elbow fitting 20 and a second gasket 17 arranged between the second plane surface 6 and the counterpart 21.

The new connector 19 is simple, easy to assemble on a filter plate 1 and cheap to manufacture. The flow resistance at the inlet 24 to the elbow fitting 20 is relatively low. The reduced flow resistance at this point can be used to increase the filtration capacity of the filter plate. Alternatively, if the flow rate achieved is adequate, the thickness of the membrane can be increased correspondingly without reducing filtering capacity of the filter plate.

The new connector 19 comprises two parts 20, 21 clamped against the filter plate 1 by only one bolt 22 placed in the through hole 9 bored in the filter plate 1. The structure is simpler than in several currently used filter plate embodiments.

The connector 19 can be permanently attached to a suction hose of a specific character. Preferably, a hose is being used that can flex outwards to prevent pressure shocks but cannot flex inwards due to a spiral inset. A normal soft hose would collapse due to vacuum and prevent the free flow of liquid.

The edge of the base 7 of the filter plate 1 can be kept intact when the connector is mounted on the plane surface 5 of the filter plate. The cross-sectional area of the filtrate outlet, that is, the open area between the through hole 9 and the cavity 3, can be made larger than when using conventional connector structures mounted on the edge of the base 7 of the sector plate 10. For instance, in an embodiment of FIG. 5, the cavity length exposed to connector 19 is 157 mm, whereas in an embodiment of FIG. 2 the length exposed to connector 11 is as low as 105 mm.

It is obvious to a person skilled in the art that with the advancement of technology, the basic idea of the invention may be implemented in various ways. The invention and its embodiments are thus not limited to the examples described above; instead they may vary within the scope of the claims.

1. A connector for placing an internal cavity of a filter plate in fluid communication with a drainage line of a disc filter, wherein the connector comprises an elbow fitting connectable onto a first plane surface a filter plate, a counterpart connectable onto a second plane surface of the filter plate, and a bolt for fastening the elbow fitting to the counterpart, which elbow fitting comprises an inlet connectable to the internal cavity of the filter plate and an outlet connectable to the drainage line of the disc filter so that the elbow fitting is able to act as a fluid communication channel between the internal cavity and the drainage line.

2. A connector according to claim 1, wherein the elbow fitting comprises a first bushing protruding through the center of the inlet and the counterpart comprises a second bushing, and the bolt is surrounded by the first bushing and second bushing.

3. A connector according to claim 2, wherein the bushings are partly overlapping and there is one or more O-ring seals arranged between the overlapping parts of the bushings.

4. A connector according to claim 1, wherein the counterpart comprises one or more lugs for locking the counterpart into an opening in the second plane surface of the filter plate.

5. A filter plate configured to connect and co-operate with a connector according to claim 1.
